(19) United States
(12) Patent Application Publication
(10) Pub. No.: US 2010/0258533 A1
(43) Pub. Date: Oct. 14, 2010

(54) METHOD AND APPARATUS FOR THE PROCESSING, IN PARTICULAR THE SEPARATING, OF WORKPIECES

(75) Inventors: Dirk Foertsch, Waldalgesheim (DE); Albrecht Seidl, Niedernberg (DE); Klaus Gerstner, Bischofsheim (DE); Thorsten Grahl, Moembris (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT AG and WACKER SCHOTT SOLAR Gmbh

(21) Appl. No.: 12/753,490

(22) Filed: Apr. 2, 2010

(30) Foreign Application Priority Data
Apr. 3, 2009 (DE) 10 2009 016 125.2

(51) Int. Cl. B23H 1/00; B23K 26/38

(52) U.S. Cl. 219/68; 219/121.69

(57) ABSTRACT

Methods and apparatus for separating of parts from workpieces is provided, in which at least one part is separated from a workpiece by means of radiation, in particular by means of laser radiation, and in which the radiation acts on the workpiece in a zone of interaction in such a way that regions of the workpiece are abraded, changed in their shape and/or are separated; in which the light intensity is received from the interaction zone and/or its vicinity and is transformed into electrical signals by a photoelectric sensor, and in which, with use of the electrical signals, it is determined when the processing procedure is to be terminated.

### CROSS REFERENCE TO RELATED APPLICATIONS

This application claims benefit under 35 U.S.C. §119(a) of German Patent Application No. 10 2009 016 125.2, filed Apr. 3, 2009, the entire contents of which are incorporated herein by reference.

### BACKGROUND OF THE INVENTION

1. Field of the Invention

The invention relates to methods and apparatus for the processing and, in particular, methods and apparatus for the separating of workpieces.

2. Description of Related Art

For producing silicon wafers according to the EFG (edge-defined film-fed growth) method for photovoltaic applications, the prepared silicon initial material is melted down and drawn into a 12-cornered tube in a drawing process. See FIG. 1. The required wafer geometries are cut out from the tube in a subsequent finishing step by means of a laser cutting assembly. In order to separate the wafer from the tube in a proper manner, the laser beam repeatedly passes through cutting paths. See FIGS. 2 and 3. The number of through-passes is called the number of cycles and is filed in the parameterization for the cutting assembly.

The number of cycles must be selected so as to cut out the wafer in a reliable manner. In addition to other parameters, the required number of cycles is essentially dependent on the material thickness of the EFG tube, which varies under certain circumstances from side to side of the tube as well as also over the length of the tube. As a consequence of conservative parameterization, cycles are repeated many times, even though the wafer has already been completely separated from the EFG tube.

### BRIEF SUMMARY OF THE INVENTION

It is an object of the invention to save process time when separating workpieces.

It is a further object of the invention to determine the necessary separating cycles for separating workpieces.

According to invention, light passing through a cutting zone is analyzed to determine when the processing procedure is to be terminated.

The advantage and utilization of the method presented according to invention lies essentially in saving process time. See, for example, FIGS. 7, 8, 9, 10 and 11. The number of cutting cycles that was previously rigidly set has led in the past to the fact that process time was unnecessarily wasted, each time depending on the material thickness, since the cutting assembly under certain circumstances had to repeatedly pass through the channel from which the wafer was already separated.

The method which is presented here determines dynamically for each step the necessary number of cutting cycles and generates a signal to an overriding control, which can then terminate the cutting process in a corresponding manner. See FIGS. 3, 4, 5, 6 and 9.

### BRIEF DESCRIPTION OF THE SEVERAL VIEWS OF THE DRAWINGS

The invention will be described in more detail below on the basis of preferred embodiments with reference to the appended drawings. Herein:

FIG. 1 shows a silicon wafer preform for photovoltaic applications which has been produced according to the EFG (edge-defined film-fed growth) method and drawn into a 12-cornered tube 1 as well as two silicon pieces 2 separated from the tube, shown in an oblique view below the table;

FIG. 2 shows a schematized representation of the course of the cyclic separation process, in which a laser beam 3 is guided repeatedly along a separating line 4 in order to separate at least one silicon wafer 2 from the 12-cornered tube;

FIG. 3 shows a schematized representation of a cutting assembly 10 in the operating state with its principal components for processing a silicon wafer which has been produced according to the EFG (edge-defined film-fed growth) method from a drawn 12-cornered tube;

FIG. 4 shows a schematized sectional view of a module 20 according to the invention with a first measuring structure for detecting an electrical signal received by a photoelectric sensor 22 during a cutting cycle, the signal being the light intensity from the zone of interaction of a laser beam 23 associated with the silicon wafer 2 and/or its vicinity;

FIG. 5 shows a schematized sectional view of a module 30 according to the invention with a second measuring structure for detecting an electrical signal received by a photoelectric sensor 22 during a cutting cycle;

FIG. 6 shows a schematized sectional view of a module according to the invention with the first measuring structure 21 for detecting the electrical signal received by the photoelectric sensor 22 during a cutting cycle;

FIG. 7 shows a recording of the electrical signal received by the photoelectric sensor 22 during a cutting cycle as a function of time or as a function of the number of images of an image recording apparatus 21 with a frame frequency that is essentially constant in time;

FIG. 8 shows a recording of the electrical signal received by the photoelectric sensor 22 during several cutting cycles as a function of time or as a function of the number of images of the image recording apparatus 21 with a frame frequency that is essentially constant in time;

FIG. 9 shows the representation of a test series for optimizing the cutting time, in which the respective cutting time required for the complete separation of a silicon wafer from a silicon material drawn into a 12-cornered tube is indicated for conventional separation methods and for a separation method according to the invention for approximately 100 separating steps (here it is already clearly shown that optimization can be obtained only according to the invention, since the respective scatter is very high);

FIG. 10 shows a recording of the electrical signal received by the photoelectric sensor 22 during three cutting cycles as a function of time or as a function of the number of images of an image recording apparatus 21 with a frame frequency that is essentially constant in time for a separation process that has been optimized relative to cutting time according to the invention;

FIG. 11 shows the output signal associated with intensity for imaging camera systems with high dynamic range; and

FIG. 12 shows a recording of the electrical signal received by the available camera system represented by the characteristic lines as shown in FIG. 8 during several cutting cycles as a function of time or as a function of the number of images.

### DETAILED DESCRIPTION OF THE INVENTION

The following definitions will be taken up in order to better understand the invention.

Radiation is the processing radiation acting on the workpiece, e.g., the laser radiation; in contrast, light designates the light that is detectable and originates from the processing zone. In this way, a decoupling of the measured wavelengths from the wavelengths of the processing radiation is achieved, in order to also not exclude spectrally shifted emissions, secondary emissions, thermal radiation and possibly other emissions arising by interaction for the purposes of the present invention.

The terms “abraded” or “changed in their shape” will particularly comprise evaporating or vaporizing, chemical reactions, such as oxidizing, or also melting, melting down, producing cracks or break lines.

A safety-aligned monitoring of the assembly includes detecting the course of intensity, checking that pre-given intensity limit values of the light detected by the sensor are maintained.

By monitoring the maintenance of limit values, the assembly can be stopped or can be placed in a state of rest in a defined manner if these limit values are exceeded, so that in this way, very basic and important functions directed toward safety are realized.

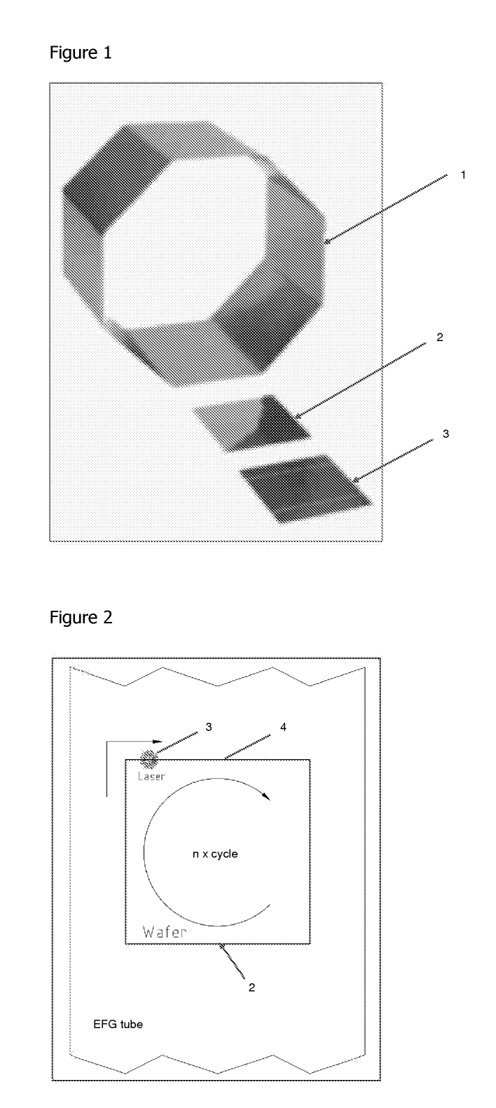

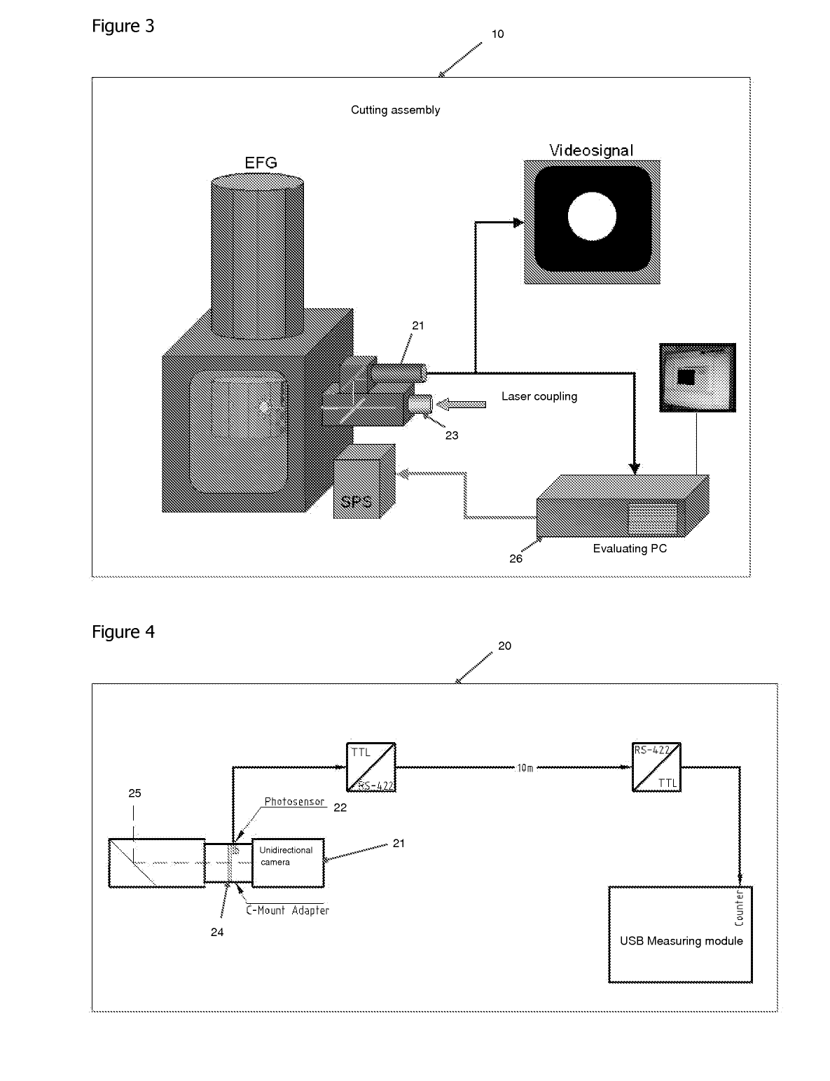

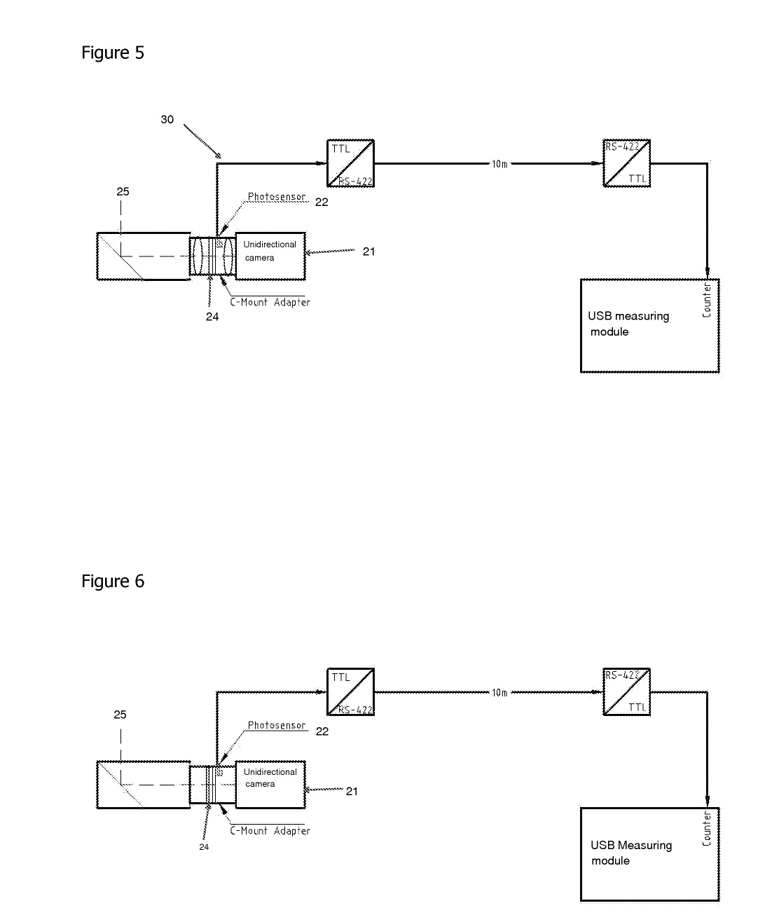

For producing silicon wafers according to the EFG (edge-defined film-fed growth) method for photovoltaic applications, the prepared silicon initial material is melted down and drawn into a 12-cornered tube 1 in a drawing process; see FIG. 1.

The required wafer geometries 2 are cut out from the tube 1 in a subsequent finishing step by means of a laser cutting assembly. In order to separate the wafer 2 from the tube 1 in a proper manner, the laser beam 3 repeatedly passes through cutting paths 4 (FIG. 2). The number of through-passes is called the number of cycles and is filed in the assembly parameterization.

The number of cycles must be selected so that the wafer 2 is always reliably cut out. In addition to other parameters, the required number of cycles is essentially dependent on the material thickness of the EFG tube 1, which varies under certain circumstances from side to side of the tube as well as also over the length of the tube. As a consequence of conservative parameterization, cycles are repeatedly passed through, even though the wafer has already been completely separated from the EFG tube.

The method presented here determines the time point when the wafer 2 has actually been separated from the EFG tube 1. For this purpose, the back-reflection of laser energy that arises during the laser processing is detected and evaluated.

The method depicted here as well as the depicted apparatus are also suitable for semiconductor strips produced according to the string-ribbon method and in general also for semiconductor wafers.

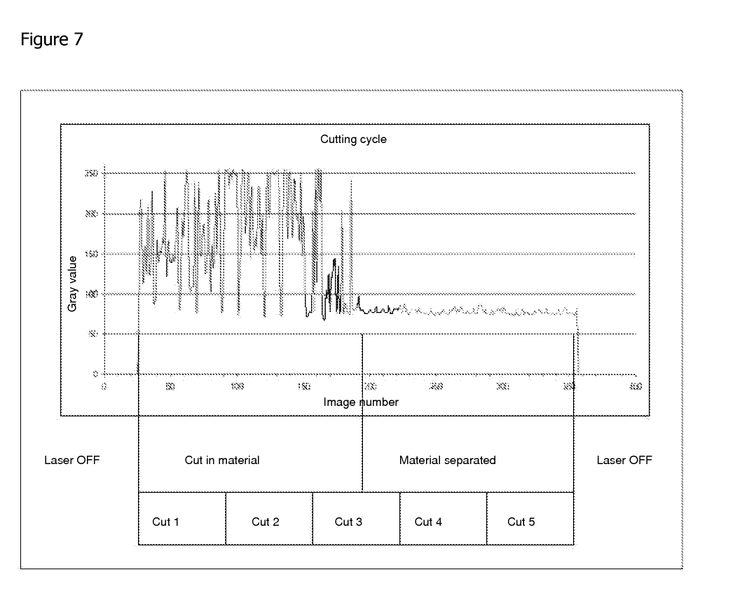

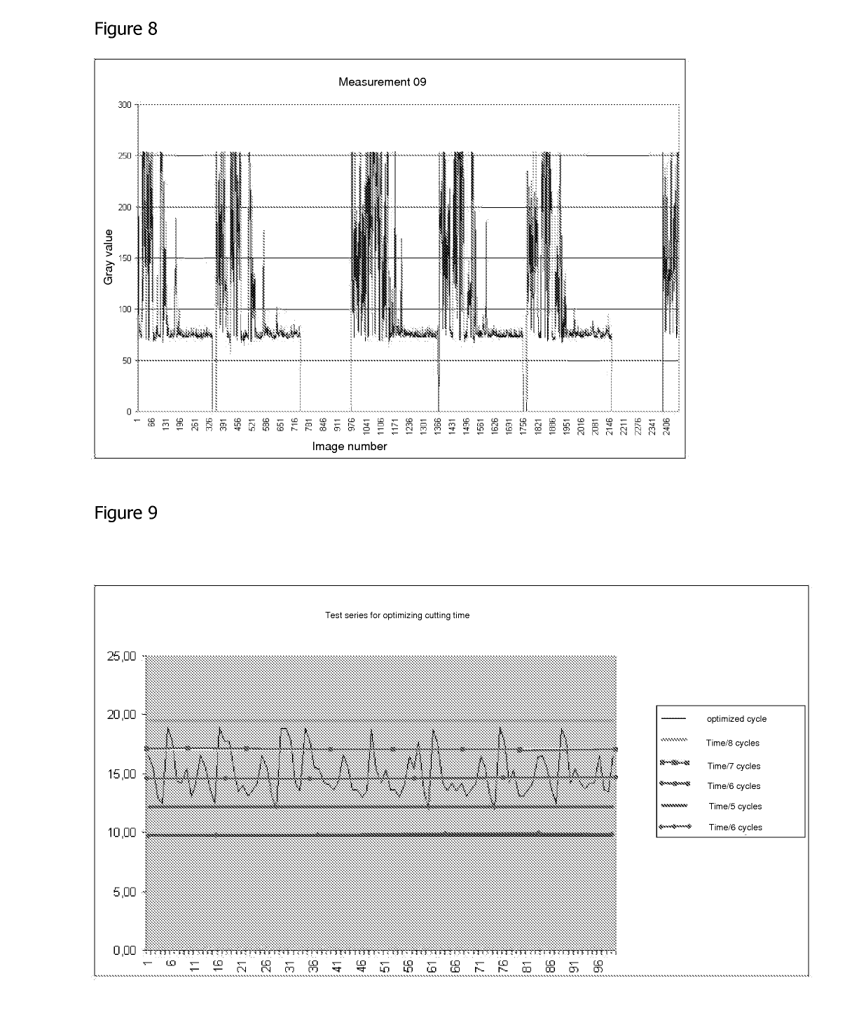

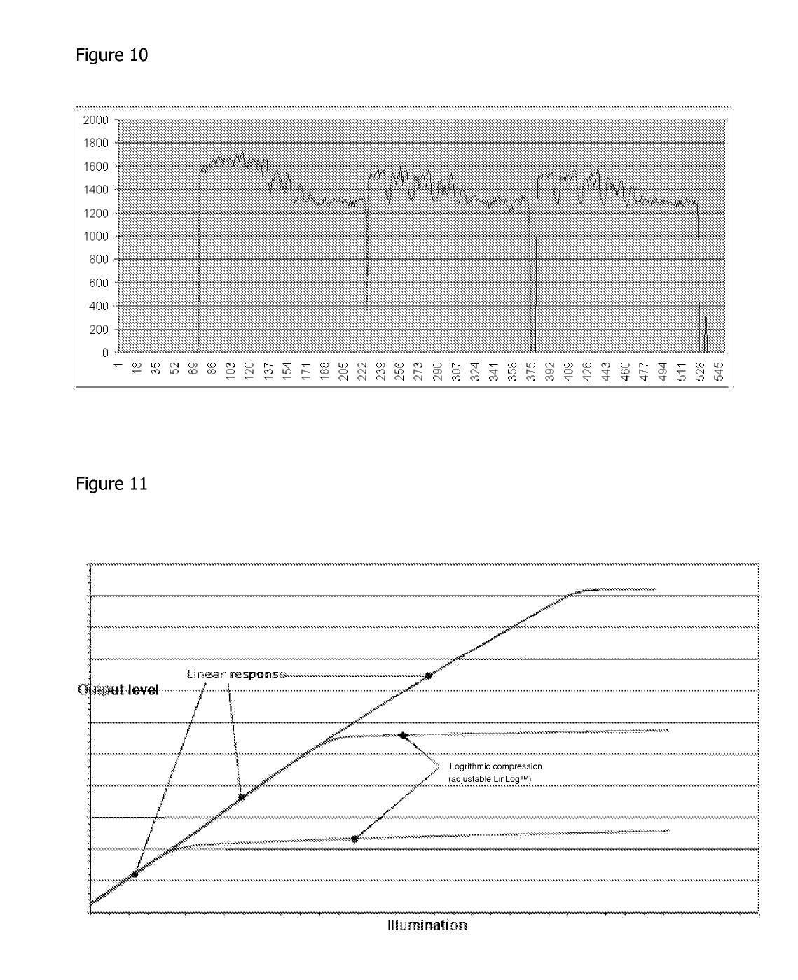

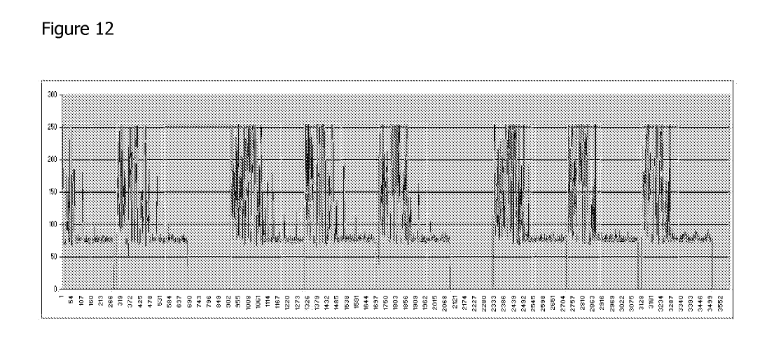

A portion of the laser energy which is back-reflected by one or more semi-transparent mirrors 24 reaches the detection unit via a beam path 25 that is independent from the laser beam 23. The intensity of the light of the detected back-reflection from the laser beam and, optionally, other light from the zone of interaction or its vicinity is transformed into a signal that can be evaluated electronically. The time course of the intensity signal is evaluated by means of a downstream evaluating electronics unit 26 and evaluating software. Since the intensity of the laser back-reflection is dependent on the processing depth, in this way it can be detected whether the laser is still found on the material to be cut or is found in a channel after the material has been cut through. See FIGS. 7, 8, 10 and 12.

The method described here or the apparatus described here can also be used for other elements of process control, such as, e.g., recognition of contaminants in the beam path, damage to the cutting nozzle, degradation of power in the beam source, detecting if the laser beam is out of alignment, and other disturbances.

What is claimed is:

1. A method for processing a workpiece, comprising the steps of:
directing radiation on the workpiece in a zone of interaction so as to abrade material from the workpiece,
receiving light from at least the zone of interaction,
transforming the light into electrical signals, and
evaluating the electrical signals to determine whether to repeat the directing, receiving and transforming steps.

2. The method of claim 1, wherein the step of directing radiation comprises directing laser radiation, wherein the step of receiving light comprises receiving light reflected back from at least the zone of interaction, wherein the step of transforming the light comprises transforming the light in to signal segments, the signal segments being representative of an intensity of the light, and wherein the step of evaluating is carried out on the signal segments to optimize a processing time.

3. The method of claim 2, wherein the processing is laser cutting and wherein the signal segments comprise a reduced intensity when separation of the workpiece is completed.

4. The method according to claim 2, wherein the signal segment has a reduced fluctuation, which is a first derivative of the electrical signal that is variable in time associated with the intensity at a corresponding time point or a derivative of the transformed electrical signal that is variable in time at a corresponding time point.

5. The method of claim 2, wherein the step of receiving light further comprises using imaging methods to detect the intensity of the light reflected back from at least the zone of interaction.

6. The method according to claim 1, further comprising controlling a photoelectric sensor to transform the light into the electrical signals and controlling an electronic measuring transducer to detect and intensity of the electrical signals.

7. The method according to claim 6, further comprising transforming the electrical signals from the photoelectric sensor into oscillating electrical signals.

8. The method according to claim 6, wherein the signal segment has a reduced fluctuation, which is a first derivative of the electrical signal that is variable in time associated with the intensity at a corresponding time point or a derivative of the transformed electrical signal that is variable in time at a corresponding time point.

9. The method according to claim 1, further comprising spectrally filtering the light received from the zone of interaction.

10. The method according to claim 1, further comprising controlling an electrically variable and adjustable attenuating element to reduce an intensity of the light received from the zone of interaction.

11. The method according to claim 1, wherein the workpiece is a semiconductor produced by an edge-defined film-fed growth method.

12. The method according to claim 1, wherein the workpiece is a semiconductor strip produced according to a string-ribbon method.

13. The method according to claim 1, wherein the workpiece is a semiconductor wafer.

14. The method according to claim 1, wherein the workpiece comprises a 12-cornered tube having a plurality of separate silicon wafers thereon.

15. A module for an apparatus for processing workpieces, comprising:
a photoelectric sensor,
an optical arrangement for guiding light from an interaction zone to the photoelectric sensor, the interaction zone belonging to a workpiece which is processed by radiation in such a way that regions of the workpiece are abraded, changed in their shape and/or are separated,
the photoelectric sensor transforming an intensity of the light into electrical signals,
a device for processing the electrical signals received from the photoelectric sensor so as to determine when a processing procedure is to be terminated and when a complete and reliable separation of the workpiece is achieved.

16. The module according to claim 15, wherein the optical arrangement comprises a unidirectional camera having a beam bath, the photoelectric sensor being disposed inside the beam path.

17. The module according to claim 16, wherein the unidirectional camera has an imaging lens, the photoelectric sensor being disposed in the imaging lens.

18. The module according to claim 15, further comprising a device for transforming the electrical signals of the photoelectric sensor into alternating-frequency signals, the device comprising a voltage controlled oscillator that generates frequencies proportional to a voltage arising at a defined resistance due to a photoelectric current.

19. The module according to claim 15, further comprising a memory-programmable control, an apparatus control device, or a safety-monitoring device, wherein the device for processing the electrical signals is configured, for determining whether the processing procedure is to be terminated, to guide a signal to the memory-programmable control, the apparatus control device, or the safety-monitoring device.

20. The module according to claim 15, further comprising a spectral filter disposed in front of the photoelectric sensor receiving the light, the filter having a spectral passband region that contains the spectral bands of an emission region of the workpiece.

21. The module according to claim 15, further comprising an attenuating component for reducing the intensity of the light originating from the interaction zone and/or the vicinity of the interaction zone in a defined manner.

22. The module according to claim 21, wherein the attenuating component is electrically variable or adjustable, and comprises a neutral-density filter that can be adjusted in a motor-driven manner, or an electrochrome element and/or an LCD screen.

23. The module according to claim 15, further comprising a ground-glass disk condenser optics unit, the optics unit being disposed in front of the photoelectric sensor in the direction of light diffusion.
